(19) United States
(12) Patent Application Publication
(10) Pub. No.: US 2022/0135797 A1
(43) Pub. Date: May 5, 2022

(54) POLYIMIDE FILM AND METHOD FOR MANUFACTURING SAME

(71) Applicant: Zhen Ding Technology Co., Ltd., Tayuan (TW)

(72) Inventors: WEI-HSIN HUANG, Tayuan (TW); KUAN-WEI LEE, Tayuan (TW); SZU-HSIANG SU, Taoyuan (TW); PEI-JUNG WU, Taoyuan (TW); SHOU-JUI HSIANG, Tayuan (TW)

(21) Appl. No.: 17/105,960

(22) Filed: Nov. 27, 2020

(30) Foreign Application Priority Data
Oct. 29, 2020 (CN) 202011183306.7

(51) Int. Cl. C08L 79/08; C08G 69/32; C08G 73/10

(52) U.S. Cl. CPC C08L 79/08; C08G 69/32; C08L 2205/12; C08L 2203/16; C08G 73/1028

(57) ABSTRACT

A polyimide film with improved dielectric and mechanical properties includes a polyimide layer with a liquid crystal structure which incorporates liquid crystal polymer powder. The polyimide layer is formed by a condensation reaction applied to dianhydride and diamine monomers, at least one of the dianhydride monomer and the diamine monomer having the liquid crystal structure. A method for manufacturing the polyimide film is also disclosed.

### FIELD

The subject matter herein generally relates to polyimide for printed circuits, especially to a polyimide film with improved dielectric and mechanical properties and a method for manufacturing the same.

### BACKGROUND

Electronic products require increasingly thinner, smaller and lightweight print circuit boards (PCB). High frequencies in wireless internet and communication devices require an insulation layer of the printed circuit board with good dielectric properties. A material of the insulation layer is usually polyimide but existing polyimide is not optimal. One solution is adding polytetrafluoroethylene into the polyimide but such addition reduces the mechanical properties of the polyimide film.

### BRIEF DESCRIPTION OF THE DRAWINGS

Implementations of the present technology will now be described, by way of embodiment, with reference to the attached figure.

FIG. 1 is a flowchart of a method for manufacturing a polyimide film in accordance with an embodiment.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

The term “comprising,” when utilized, means “including, but not necessarily limited to”; it specifically indicates open-ended inclusion or membership in the so-described combination, group, series, and the like. When a first component is referred to as “connecting” to a second component, it is intended that the first component may be directly connected to the second component or may be indirectly connected to the second component via a third component between them.

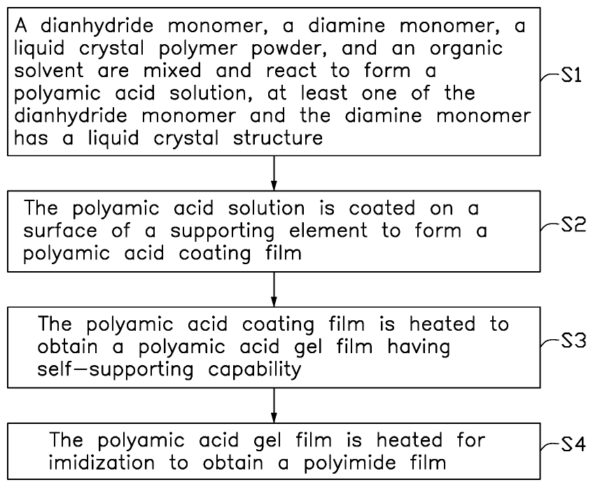

Referring to FIG. 1, a flowchart of one embodiment of a method is illustrated. The example method is provided by way of example, as there are a variety of ways to carry out the method. Each block shown in FIG. 1 represents one or more processes, methods or subroutines, carried out in the exemplary method. Additionally, the illustrated order of blocks is by example only and the order of the blocks can change. The exemplary method can begin at block S1.

At block S1, a dianhydride monomer, a diamine monomer, a liquid crystal polymer powder, and an organic solvent are mixed and react together to form a polyamic acid solution, at least one of the dianhydride monomer and the diamine monomer has a liquid crystal structure.

At block S2, the polyamic acid solution is coated on a surface of a supporting element to form a polyamic acid coating film.

At block S3, the polyamic acid coating film is heated to obtain a polyamic acid gel film having self-supporting capability.

At block S4, the polyamic acid gel film is heated for imidization to obtain a polyimide film.

The polyamic acid solution includes the polyamic acid having the liquid crystal structure, the liquid crystal polymer powder, and the organic solvent. The polyamic having the liquid crystal structure is formed by a condensation reaction applied to the dianhydride and diamine monomers. The liquid crystal polymer powder is uniformly dispersed in the polyamic acid solution. An essential unit of the liquid crystal structure is represented by the following formulaic structure:

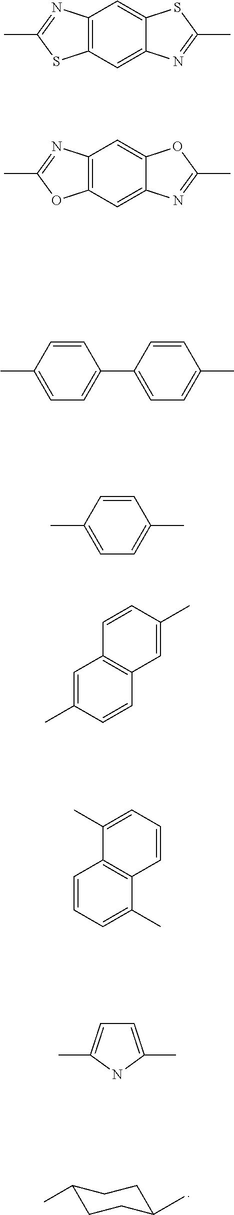

According to an embodiment, a weight percentage of the organic solvent in the polyamic acid solution is in a range of approximately 15% to approximately 20%, a weight percentage of the polyamic acid having the liquid crystal structure a solid substance of the polyamic acid solution is in a range of approximately 95% to approximately 97%, and a weight percentage of the liquid crystal polymer powder in the solid substance of the polyamic acid solution is in a range of approximately 3% to approximately 5%. An average particle size of the liquid crystal polymer powder is less than 3 μm.

According to an embodiment, the diamine monomer without the liquid crystal structure is selected from a group consisting of 4,4′-diaminodiphenyl ether (ODA), p-phenylenediamine (p-PDA), and 3,5-diamino-1,2,4-triazole (DTZ).

According to an embodiment, the diamine monomer having the liquid crystal structure is selected from a group consisting of cyclohexane-1,4-diylbis(methylene)bis(1,3-dioxo-1,3-dihy-droisobenzofuran-5-carboxyla te) (TA-CHDM), 4-Aminobenzoic acid 4-aminophenyl ester (APAB), 1,4-Bis(4-aminobenzo-yloxy)benzene (ABHQ), and 1,4-Benzenedicarboxylic acid bis(4-aMinophenyl) ester (BPTP).

According to an embodiment, the dianhydride monomer without the liquid crystal structure is selected from a group consisting of tetrabenzoic dianhydride (PMDA), 4,4′-(hexafluoroisopropylene) diphthalic anhydride (6FDA), and 1,2,3,4-cyclobutane Carboxylic dianhydride (CBDA).

According to an embodiment, the dianhydride monomer having the liquid crystal structure is selected from a group consisting of 3,3′,4,4′-biphenyltetracarboxylic dianhydride (BPDA) and p-Phenylene bis(trimellitate) dianhydride (TAHQ).

A mole ratio of the diamine monomer to the dianhydride monomer is 1:1. According to an embodiment, a mole percentage of ODA in the diamine and dianhydride monomers is approximately 15%, a mole percentage of APAB in the diamine and dianhydride monomers is approximately 35%, and a mole percentage of BPDA in the diamine and dianhydride monomers is approximately 50%.

The liquid crystal polymer powder is insoluble in the organic solvent. According to an embodiment, the organic solvent is selected from a group consisting of dimethylacetamide (DMAc), N-methylpyrrolidone (NMP), and N,N-dimethylformamide (DMF).

According to an embodiment, the step of forming the polyamic acid solution includes adding the diamine monomer and the liquid crystal polymer powder into the organic solvent, stirring until the diamine monomer is completely dissolved, then adding dianhydride monomer into the organic solvent. The polyamic acid solution is obtained by reacting the diamine monomer with the dianhydride monomer in the organic solvent, the liquid crystal polymer powder being dispersed therein, for approximately 45 to 50 hours in a nitrogen environment.

The supporting element may be a glass plate or a steel plate. The polyamic acid solution may be flow-cast or extrusion molded on the surface of the supporting element.

According to an embodiment, the step of obtaining a self-supporting polyamic acid gel film includes heating the polyamic acid coating film to remove a part of the organic solvent, and peeling the polyimide coating film after the part of the solvent is removed from the supporting element. When heating the polyamic acid coating film to remove a part of the organic solvent, the liquid crystal polymer powder does not melt, facilitating the peeling of the polyamic acid gel film. According to an embodiment, a heating temperature of the polyamic acid coating film is in a range of approximately 130° C. to approximately 150° C., and a heating time is in a range of approximately 10 minutes to approximately 20 minutes.

When the polyamic acid gel film is heated, the polyamic acid having the liquid crystal structure undergoes a dehydration ring-closure imidization reaction and produces a liquid crystal arrangement. The molten liquid crystal polymer powder is distributed between the polyamic acid arranged in the liquid crystal, and the liquid crystal structure of the molten liquid crystal polymer powder and the liquid crystal structure of the polyamic acid crystallize to form physical crosslinks, thereby forming a network structure.

The polyimide film includes a polyimide layer with the liquid crystal structure which incorporates liquid crystal polymer powder. The polyimide layer is formed by a dehydration ring-closure imidization reaction applied to the polyamic acid with the liquid crystal structure which is formed by a condensation reaction applied to the dianhydride monomer and the diamine monomer. A weight percentage of the polyimide layer in the polyimide film is in a range of approximately 95% to approximately 97%, a weight percentage of the liquid crystal polymer powder in the polyimide film is in a range of approximately 3% to approximately 5%. The liquid crystal structure of the liquid crystal polymer powder and the liquid crystal structure of the polyimide layer crystallize to form physical crosslinks, thereby forming a network structure, so that mechanical properties of the polyimide film are improved.

Furthermore, the method further includes a step of stretching at least one of the polyamic acid gel film and the polyimide film.

In the polyimide film, the liquid crystal polymer powder is incorporated in the polyimide layer with the liquid crystal structure, so that the polyimide film has a low dielectric constant and loss factor. In addition, the liquid crystal structure of the polyimide and the liquid crystal structure of the liquid crystal polymer powder are physically cross-linked, so that the polyimide film has excellent mechanical properties. In the method, the liquid crystal polymer powder is incorporated in the polyamic acid gel film, which facilitates the peeling of the polyamic acid gel film.

The present disclosure is illustrated by way of different examples.

### EXAMPLE 1

Approximately 80 g of DMAC was added into a reaction flask. Then approximately 2.27 g (0.0113 mol) of ODA, approximately 6.03 g (0.0264 mol) of APAB, and approximately 0.6 g of LF31-P (aromatic liquid crystal polyester) were added into the solvent, which was continuously agitated until ODA and APAB were completely dissolved. Then approximately 11.10 g (0.0377 mol) of BPDA was added into the solution, and reacted for 48 hours in a nitrogen environment. Thereby, 100 g of polyamic acid solution was obtained.

### EXAMPLE 2

Approximately 80 g of DMAC was added into a reaction flask. Then approximately 2.24 g (0.0112 mol) of ODA, approximately 5.97 g (0.0262 mol) of APAB, and approximately 0.8 g of LF31-P were added into the solvent, which was continuously agitated until ODA and APAB were completely dissolved. Then approximately 10.99 g (0.0374 mol) of BPDA was added into the solution and reacted for 48 hours in a nitrogen environment. Thereby, 100 g of polyamic acid solution was obtained.

### EXAMPLE 3

Approximately 80 g of DMAC was added into a reaction flask. Then approximately 2.22 g (0.0111 mol) of ODA, approximately 5.91 g (0.0259 mol) of APAB, and approximately 1 g of LF31-P were added into the solvent, which was continuously agitated until ODA and APAB were completely dissolved. Then approximately 10.87 g (0.0369 mol) of BPDA was added into the solution and reacted for 48 hours in a nitrogen environment. Thereby, 100 g of polyamic acid solution was obtained.

### Comparative Example 1

Approximately 80 g of DMAC was added into a reaction flask. Then approximately 2.34 g (0.0117 mol) of ODA and approximately 6.22 g (0.0272 mol) of APAB were added into the solvent, which was continuously agitated until ODA and APAB were completely dissolved. Then approximately 11.45 g (0.0389 mol) of BPDA was added into the solution and reacted for 48 hours in a nitrogen environment. Thereby, 100 g of polyamic acid solution was obtained.

### Comparative Example 2

Approximately 80 g of DMAC was added into a reaction flask. Then approximately 2.31 g (0.0115 mol) of ODA, approximately 6.15 g (0.0269 mol) of APAB, and approximately 0.2 g of LF31-P were added into the solvent, which was continuously agitated until ODA and APAB were completely dissolved. Then approximately 11.33 g (0.0385 mol) of BPDA was added into the solution and reacted for 48 hours in a nitrogen environment. Thereby, 100 g of polyamic acid solution was obtained.

### Comparative Example 3

Approximately 80 g of DMAC was added into a reaction flask. Then approximately 2.29 g (0.0114 mol) of ODA, approximately 6.09 g (0.0267 mol) of APAB, and approximately 0.4 g of LF31-P were added into the solvent, which was continuously agitated until ODA and APAB were completely dissolved. Then approximately 11.22 g (0.0381 mol) of BPDA was added into the solution and reacted for 48 hours in a nitrogen environment. Thereby, 100 g of polyamic acid solution was obtained.

### Comparative Example 4

Approximately 80 g of DMAC was added into a reaction flask. Then approximately 2.2 g (0.011 mol) of ODA, approximately 5.84 g (0.0256 mol) of APAB, and approximately 1.2 g of LF31-P were added into the solvent, which was continuously agitated until ODA and APAB were completely dissolved. Then approximately 10.76 g(0.0366 mol) of BPDA was added into the solution and reacted for 48 hours in a nitrogen environment. Thereby, 100 g of polyamic acid solution was obtained.

### Comparative Example 5

Approximately 80 g of DMAC was added into a reaction flask. Then approximately 9.57 g (0.0478 mol) of ODA was added into the solvent, which was continuously agitated until ODA was completely dissolved. Then approximately 10.43 g (0.0478 mol) of PMDA was added into the solution and reacted for 48 hours in a nitrogen environment. Thereby, 100 g of polyamic acid solution was obtained.

### Comparative Example 6

Approximately 80 g of DMAC was added into a reaction flask. Then approximately 9.19 g (0.0478 mol) of ODA and 0.8 g of LF31-P were added into the solvent, which was continuously agitated until ODA was completely dissolved. Then approximately 10.01 g (0.0478 mol) of PMDA was added into the solution and reacted for 48 hours in a nitrogen environment. Thereby, 100 g of polyamic acid solution was obtained.

### Comparative Example 7

Approximately 80 g of DMAC was added into a reaction flask. Then approximately 2.27 g (0.0113 mol) of ODA, 6.03 g (0.0264 mol) of APAB, and 0.6 g of PTFE (polytetrafluoroethylene) were added into the solvent, which was continuously agitated until ODA and APAB were completely dissolved. Then approximately 11.10 g (0.0377 mol) of BPDA was added into the solution and reacted for 48 hours in a nitrogen environment. Thereby, 100 g of polyamic acid solution was obtained.

### Comparative Example 8

Approximately 80 g of DMAC was added into a reaction flask. Then approximately 2.24 g (0.0112 mol) of ODA, 5.97 g (0.0261 mol) of APAB, and 0.8 g of PTFE were added into the solvent, which was continuously agitated until ODA and APAB were completely dissolved. Then approximately 10.99 g (0.0374 mol) of BPDA was added into the solution and reacted for 48 hours in a nitrogen environment. Thereby, 100 g of polyamic acid solution was obtained.

### Comparative Example 9

Approximately 80 g of DMAC was added into a reaction flask. Then approximately 2.22 g (0.0111 mol) of ODA, 5.91 g (0.0259 mol) of APAB, and 1 g of PTFE were added into the solvent, which was continuously agitated until ODA and APAB were completely dissolved. Then approximately 10.87 g (0.0369 mol) of BPDA was added into the solution and reacted for 48 hours in a nitrogen environment. Thereby, 100 g of polyamic acid solution was obtained.

### Comparative Example 10

Approximately 80 g of DMAC was added into a reaction flask. Then approximately 2.27 g (0.0113 mol) of ODA, 6.03 g (0.0264 mol) of APAB, and 0.6 g of SiO₂ were added into the solvent, which was continuously agitated until ODA and APAB were completely dissolved. Then approximately 11.10 g (0.0377 mol) of BPDA was added into the solution and reacted for 48 hours in a nitrogen environment. Thereby, 100 g of polyamic acid solution was obtained.

### Comparative Example 11

Approximately 80 g of DMAC was added into a reaction flask. Then approximately 2.24 g (0.0112 mol) of ODA, 5.97 g (0.0261 mol) of APAB, and 0.8 g of SiO₂ were added into the solvent, which was continuously agitated until ODA and APAB were completely dissolved. Then approximately 10.99 g (0.0374 mol) of BPDA was added into the solution and reacted for 48 hours in a nitrogen environment. Thereby, 100 g of polyamic acid solution was obtained.

### Comparative Example 12

Approximately 80 g of DMAC was added into a reaction flask. Then approximately 2.22 g (0.0111 mol) of ODA, 5.91 g (0.0259 mol) of APAB, and 1 g of SiO₂ were added into the solvent, which was continuously agitated until ODA and APAB were completely dissolved. Then approximately 10.87 g (0.0369 mol) of BPDA was added into the solution and reacted for 48 hours in a nitrogen environment. Thereby, 100 g of polyamic acid solution was obtained.

Each of the polyamic acid solutions obtained in examples 1-3 and comparative examples 1-12 was coated onto a steel plate, followed by drying at approximately 140° C. for 15 minutes to obtain a polyamic acid gel film. Then the polyamic acid gel film was peeled off the steel plate, followed by stretching and ring-closing dehydration by heating at approximately 350° C. to 370° C. for approximately 30 to 60 minutes in a nitrogen environment, resulting in a polyimide film. The component contents of the polyimide films prepared in examples 1-3 and comparative examples 1-12 are shown in Table 1.

A peel test was performed on the polyamic acid films prepared in examples 1-3 and comparative examples 1-12, and the tensile strength, the elongation, the dielectric properties (dielectric constant Dk, loss factor Df), and the water absorption of the polyimide films prepared in examples 1-3 and comparative examples 1-12 were tested. The test results are shown in Table 2.

TABLE 1

| | A mole | A mole | A mole | A mole | A weight | A weight | A weight |
|---|---|---|---|---|---|---|---|
| | percentage | percentage | percentage | percentage | percentage | percentage | percentage |
| | of ODA | of APAB | of BPDA | of PMDA | of LF31-P | of PTFE | of SiO₂ |
| | (%) | (%) | (mole %) | (mole %) | (%) | (%) | (%) |
| Example 1 | 15 | 35 | 50 | — | 3 | — | — |
| Example 2 | 15 | 35 | 50 | — | 4 | — | — |
| Example 3 | 15 | 35 | 50 | — | 5 | — | — |
| Comparative | 15 | 35 | 50 | — | | — | — |
| example 1 | | | | | | | |
| Comparative | 15 | 35 | 50 | — | 1 | — | — |
| example 2 | | | | | | | |
| Comparative | 15 | 35 | 50 | — | 2 | — | — |
| example 3 | | | | | | | |
| Comparative | 15 | 35 | 50 | — | 6 | — | — |
| example 4 | | | | | | | |
| Comparative | 50 | — | — | 50 | — | — | — |
| example 5 | | | | | | | |
| Comparative | 50 | — | — | 50 | 4 | | — |
| example 6 | | | | | | | |
| Comparative | 15 | 35 | 50 | — | — | 3 | — |
| example 7 | | | | | | | |
| Comparative | 15 | 35 | 50 | — | — | 4 | — |
| example 8 | | | | | | | |
| Comparative | 15 | 35 | 50 | — | — | 5 | — |
| example 9 | | | | | | | |
| Comparative | 15 | 35 | 50 | — | — | — | 3 |
| example 10 | | | | | | | |
| Comparative | 15 | 35 | 50 | — | — | — | 4 |
| example 11 | | | | | | | |
| Comparative | 15 | 35 | 50 | — | — | — | 5 |
| example 12 | | | | | | | |

TABLE 2

| | | tensile | | | | water |
|---|---|---|---|---|---|---|
| | | strength | elongation | Dk | Df | absorption |
| | peel test | (MPa) | (%) | (10 GHz) | (10 GHz) | (%) |
| Example 1 | PASS | 220 | 20 | 3.6 | 0.0024 | 0.78 |
| Example 2 | PASS | 209 | 27 | 3.5 | 0.0021 | 0.72 |
| Example 3 | PASS | 188 | 32 | 3.5 | 0.0018 | 0.67 |
| Comparative | NOT PASS | 250 | 10 | 3.7 | 0.003 | 1.5 |
| example 1 | | | | | | |
| Comparative | NOT PASS | 235 | 12 | 3.7 | 0.0028 | 1.3 |
| example 2 | | | | | | |
| Comparative | NOT PASS | 228 | 15 | 3.6 | 0.0026 | 0.93 |
| example 3 | | | | | | |
| Comparative | PASS | 172 | 29 | 3.5 | 0.0017 | 0.62 |
| example 4 | | | | | | |
| Comparative | NOT PASS | 170 | 40 | 3.5 | 0.012 | 1.8 |
| example 5 | | | | | | |
| Comparative | PASS | 158 | 39 | 3.5 | 0.011 | 1.7 |
| example 6 | | | | | | |
| Comparative | NOT PASS | 188 | 10 | 3.6 | 0.0026 | 0.84 |
| example 7 | | | | | | |
| Comparative | PASS | 175 | 10 | 3.5 | 0.0024 | 0.79 |
| example 8 | | | | | | |
| Comparative | PASS | 162 | 9 | 3.4 | 0.0022 | 0.72 |
| example 9 | | | | | | |
| Comparative | PASS | 224 | 10 | 3.7 | 0.0031 | 1.4 |
| example 10 | | | | | | |
| Comparative | PASS | 215 | 9 | 3.7 | 0.0033 | 1.4 |
| example 11 | | | | | | |
| Comparative | PASS | 207 | 9 | 3.8 | 0.0036 | 1.3 |
| example 12 | | | | | | |

Examples 1-3 and comparative examples 1-4 show that when the liquid crystal polymer powder is 3 to 5 wt % of the polyimide film, the polyamic acid gel film is easy to peel off. Polyimide film made in this way has good tensile strength, elongation, dielectric properties, and low water absorption. Conversely, when the liquid crystal polymer powder is less than 3 wt % of the polyimide film, the polyamic acid gel film is difficult to peel off, elongation is decreased, water absorption is improved, and dielectric properties are poor. In comparative examples 5 and 6, ODA and PMDA are provided to synthesize the polyimide without the liquid crystal structure. The polyimide without the liquid crystal structure cannot be physically cross-linked with the liquid crystal polymer. The tensile strength of the polyimide prepared in comparative examples 5 and 6 cannot be improved, and the dielectric properties and water absorption of the polyimide prepared in comparative examples 5 and 6 are greater than those of the polyimide with the liquid crystal structure. In comparative examples 7 to 9, PTFE with good dielectric properties is used to prepare the polyimide film, and although the prepared polyimide film has good dielectric properties, its tensile strength is decreased. In comparative examples 10 to 12, SiO₂ is used to prepare the polyimide film, and although the polyamic acid gel film is easy to peel off, elongation and the dielectric properties of the prepared polyimide film are decreased.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A polyimide film comprising a polyimide layer with a liquid crystal structure, wherein the polyimide layer incorporates a liquid crystal polymer powder, the polyimide layer is formed by a condensation reaction applied to a dianhydride monomer and a diamine monomer, at least one of the dianhydride monomer and the diamine monomer has the liquid crystal structure.

2. The polyimide film of claim 1, wherein a weight percentage of the liquid crystal polymer power in the polyimide film is in a range of approximately 3% to approximately 5%.

3. The polyimide film of claim 1, wherein the diamine monomer having the liquid crystal structure is selected from a group consisting of TA-CHDM, APAB, ABHQ, and BPTP.

4. The polyimide film of claim 3, wherein the diamine monomer without the liquid crystal structure is selected from a group consisting of ODA, p-PDA, and DTZ.

5. The polyimide film of claim 4, wherein the diamine monomer having the liquid crystal structure is selected from a group consisting of TA-CHDM, APAB, ABHQ, and BPTP.

6. The polyimide film of claim 5, the dianhydride monomer without the liquid crystal structure is selected from a group consisting of PMDA, 6FDA, and CBDA.

7. The polyimide film of claim 6, wherein a mole ratio of the diamine monomer to the dianhydride monomer is 1:1.

8. The polyimide film of claim 7, wherein the diamine and dianhydride monomers includes ODA, APAB, and BPDA, a mole percentage of ODA in the diamine and dianhydride monomers is approximately 15%, a mole percentage of APAB in the diamine and dianhydride monomers is approximately 35%, and a mole percentage of BPDA in the diamine and dianhydride monomers is approximately 50%.

9. A method for manufacturing a polyimide film comprising:
mixing a dianhydride monomer, a diamine monomer, a liquid crystal polymer powder, and an organic solvent to form a polyamic acid solution, wherein at least one of the dianhydride monomer and the diamine monomer has a liquid crystal structure;
coating the polyamic acid solution onto a surface of a supporting element to form a polyamic acid coating film;
heating the polyamic acid coating film to obtain a polyamic acid gel film having self-supporting capability;
imidizing the polyamic acid gel film by heating to obtain the polyimide film.

10. The method of claim 9, wherein the polyamic acid coating film is heated at approximately 130° C. to approximately 150° C. for approximately 10 minutes to 20 minutes.

11. The method of claim 9, wherein a weight percentage of the liquid crystal polymer powder in the polyimide film is in a range of approximately 3% to approximately 5%.

12. The method of claim 9, wherein the diamine monomer having the liquid crystal structure is selected from a group consisting of TA-CHDM, APAB, ABHQ, and BPTP.

13. The method of claim 12, wherein the diamine monomer without the liquid crystal structure is selected from a group consisting of ODA, p-PDA, and DTZ.

14. The method of claim 13, wherein the diamine monomer having the liquid crystal structure is selected from a group consisting of TA-CHDM, APAB, ABHQ, and BPTP.

15. The method of claim 14, the dianhydride monomer without the liquid crystal structure is selected from a group consisting of PMDA, 6FDA, and CBDA.

16. The method of claim 15, wherein a mole ratio of the diamine monomer to the dianhydride monomer is 1:1.

17. The method of claim 16, wherein the diamine and dianhydride monomers includes ODA, APAB, and BPDA, a mole percentage of ODA in the diamine and dianhydride monomers is approximately 15%, a mole percentage of APAB in the diamine and dianhydride monomers is approximately 35%, and a mole percentage of BPDA in the diamine and dianhydride monomers is approximately 50%.
